(19) United States
(12) Patent Application Publication
(10) Pub. No.: US 2026/0180698 A1
(43) Pub. Date: Jun. 25, 2026

(54) WIRELESS COMMUNICATION DEVICE AND METHOD

(71) Applicant: MEDIATEK INC., Hsinchu City (TW)

(72) Inventors: Tsung-Hsuan Wu, Hsinchu City (TW); Jun-Shen Chen, Hsinchu City (TW); Jia-Zhen Chen, Hsinchu City (TW); You-Wei Jheng, Hsinchu City (TW)

(21) Appl. No.: 19/096,850

(22) Filed: Apr. 1, 2025

Related U.S. Application Data
(60) Provisional application No. 63/737,841, filed on Dec. 23, 2024.

(51) Int. Cl. H04B 17/345; H04B 7/06

(52) U.S. Cl. CPC H04B 17/345; H04B 7/0617

(57) ABSTRACT

The application provides a wireless communication device and method. A beamforming sounding signal is received. An updated channel profile is generated in consideration of the beamforming sounding signal. Whether any interference is detected is determined. In response that interference is detected, a previous channel profile used in a last sounding is sent, or in response that no interference is detected, the updated channel profile is sent.

This application claims the benefit of U.S. Provisional Patent application Ser. No. 63/737,841, filed 2024 Dec. 23, the disclosure of which is incorporated by reference herein in its entirety.

### TECHNICAL FIELD

The disclosure relates to a wireless communication device and method.

### BACKGROUND

Wi-Fi beamforming works in the 2.4 GHz ISM (Industrial, Scientific, and Medical) band, but faces potential issues due to interference from other wireless technologies. The 2.4 GHz ISM band is a shared frequency range used by multiple wireless technologies, including Wi-Fi, Bluetooth (BT), and ZigBee. These different protocols can operate in overlapping frequency channels and transmit data at any time, leading to possible interference.

Beamforming is a technique used in Wi-Fi to direct a wireless signal toward a specific device (STA, station) rather than broadcasting it in all directions. To perform beamforming, the Access Point (AP) sends a sounding signal to the station, which then analyzes the signal and sends back a Channel Profile (feedback) to the AP. The AP then uses this feedback to adjust its signal transmission, optimizing the direction and strength for better range and performance.

Since other wireless devices (like Bluetooth or ZigBee) can also transmit on the same frequency at the same time, their signals can collide with the Wi-Fi beamforming sounding signal. This interference can cause the STA to misinterpret the Wi-Fi signal, leading it to send incorrect Channel Profile feedback to the AP. If the AP gets wrong feedback, it will beamform in the wrong direction or with incorrect parameters, which can reduce performance rather than improving it.

Beamforming can significantly improve Wi-Fi range and signal quality, but in the crowded 2.4 GHz band, interference from other wireless devices can disrupt the process. If the Channel Profile feedback is inaccurate, beamforming may fail or even make performance worse than if it hadn't been used at all.

Further, some coexistent applications may access this channel very frequently and for short periods. Constantly requesting an AP not to send packets can lead to overall throughput degradation.

### SUMMARY

According to one embodiment, a wireless communication method is provided. The wireless communication method includes: receiving a beamforming sounding signal; generating an updated channel profile in consideration of the beamforming sounding signal; determining whether any interference is detected; and in response that interference is detected, sending a previous channel profile used in a last sounding, or in response that no interference is detected, sending the updated channel profile

According to another embodiment, a wireless communication device is provided. The wireless communication device includes: a wireless transceiver module for transmitting and receiving wireless signals from other wireless devices; and a controller coupled to and for controlling the wireless transceiver module. The controller is configured for: receiving a beamforming sounding signal; generating an updated channel profile in consideration of the beamforming sounding signal; determining whether any interference is detected; and in response that interference is detected, sending a previous channel profile used in a last sounding, or in response that no interference is detected, sending the updated channel profile.

### BRIEF DESCRIPTION OF THE DRAWINGS

FIG. 1 shows a wireless communication device according to one embodiment of the application.

FIG. 2 shows a wireless communication method according to one embodiment of the application.

FIG. 3 shows wireless communication according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

The AP sends the sounding signals at regular, fixed intervals (e.g., every few milliseconds). This constant repetition helps the system track changes in the channel (such as movement of devices or environmental factors).

When a collision occurs, instead of sending inaccurate data, in one embodiment of the application, the STA reuses the last valid Channel Profile from the most recent sounding that did not experience a collision. This ensures the AP receives reliable data, even if the last valid Channel Profile is slightly outdated, allowance of maintaining reasonable beamforming performance until a new, valid sounding is successful.

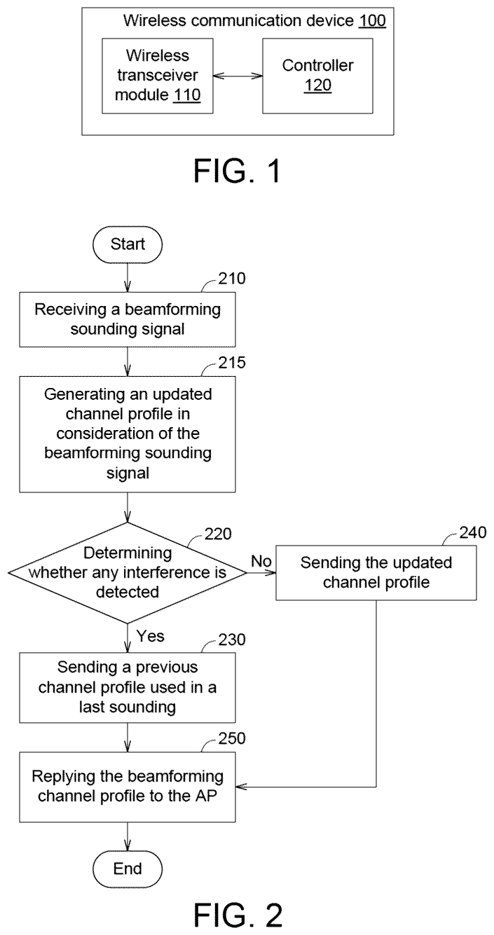

FIG. 1 shows a wireless communication device according to one embodiment of the application. The wireless communication device 100 according to one embodiment of the application includes a wireless transceiver module 110 and a controller 120. The wireless communication device 100 according to one embodiment of the application is for example but not limited by, a station having beamforming function.

The wireless transceiver module 110 is coupled to the controller 120.

The wireless transceiver module 110 is for transmitting and receiving wireless signals from other wireless devices.

The controller 120 is for controlling the wireless transceiver module 110 based on the wireless signals received by the wireless transceiver module 110. Further, the controller 120 performs the wireless communication method based on the wireless signals received by the wireless transceiver module 110 and whether any interference is detected.

FIG. 2 shows a wireless communication method according to one embodiment of the application.

At step 210, the station receives a beamforming sounding signal from the AP.

At step 215, the station generates an updated channel profile in consideration of the beamforming sounding signal.

At step 220, the station determines whether interference is detected. In possible implementation, interference detection includes, for example but not limited by, detecting interference from at least one of coexisting wireless signals comprising BT (blue tooth) signals, ZigBee signals, Wi-Fi signals and PCIE (Peripheral Component Interconnect Express) signals, and so on. If step 220 is yes, the flow proceeds to step 230. If step 220 is no, the flow proceeds to step 240.

At step 230, in response that interference is detected, the station sends a previous channel profile used in a last sounding. For example but not limited by, at step 230, the station performs beamforming channel profile engine lock and sends the previous channel profile used in the last sounding that did not experience a collision. That is to say, in one embodiment of the application, when the channel profile engine is locked, the station does not update the channel profile and instead, the previous channel profile is sent from the station to the AP.

At step 240, in response that no interference is detected, the station sends the updated channel profile. For example but not limited by, at step 240, the station performs beamforming channel profile engine unlock and sends an updated beamforming channel profile. That is to say, in one embodiment of the application, when the channel profile engine is unlocked, the station updates the channel profile and the updated channel profile is sent from the station to the AP.

At step 250, the station replies the beamforming channel profile (either the previous channel profile (step 230) or the updated beamforming channel profile (step 240)) to the AP.

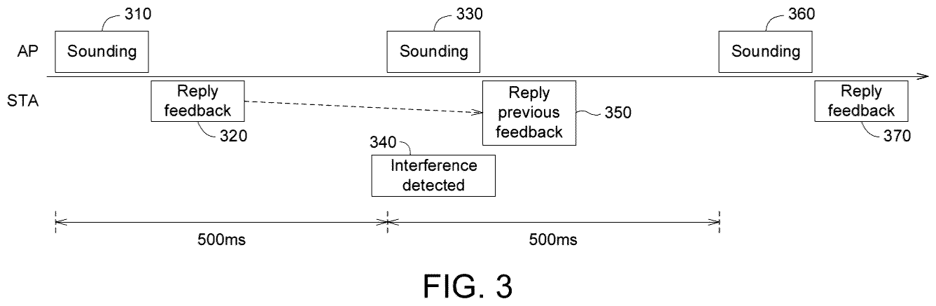

FIG. 3 shows wireless communication according to one embodiment of the application. At timing 310, the AP sends a beamforming sounding signal to the station. At timing 320, because no interference is detected by the station, the station replies an updated beamforming channel profile (step 240 in FIG. 2) to the AP.

At timing 330, the AP sends a beamforming sounding signal again to the station. At timing 340, because interference is detected by the station, the station replies a previous beamforming channel profile (step 230 in FIG. 2) to the AP at timing 350.

At timing 360, the AP sends a beamforming sounding signal to the station. At timing 370, because no interference is detected by the station, the station replies an updated beamforming channel profile (step 240 in FIG. 2) to the AP.

As described above, as beamforming sounding usually sends probes at fixed intervals, when a collision occurs between the beamforming sounding signal and signals from other wireless devices, the wireless communication device in one embodiment of the application keeps using the result from the last sounding that didn't experience a collision, and returns to the AP.

This fallback mechanism in one embodiment of the application replies the previous no-collision beamforming channel profile to the AP if any interference is detected, and thus prevents incorrect beamforming adjustments, which could degrade signal quality.

In one embodiment of the application, the application can still benefit from beamforming gains. Notably, the wireless communication method in one embodiment of the application helps avoid poor beamforming quality over the entire sounding period (for example, 500 ms).

The above primarily describes the solutions provided in the embodiments of the present application from the perspective of wireless communication. It is understood that to achieve the above functions, the wireless communication device includes corresponding hardware structures and/or software modules that execute functions. Professionals in the technical field can easily recognize that the units and algorithm steps described in the embodiments of the present application can be implemented in hardware form or a combination of hardware and software. Whether the functions are performed by hardware or by hardware driven by software depend on the specific application and design constraints of the technical solution. Professionals in the technical field can use different methods to implement the functions described in each specific application without departing from the scope of the present application.

In one embodiment of the present application, the wireless communication device can be divided into functional modules based on the aforementioned method examples. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of sub-combinations. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A wireless communication method, applied to a wireless device, the wireless communication method comprising:
receiving a beamforming sounding signal;
generating an updated channel profile in consideration of the beamforming sounding signal;
determining whether any interference is detected; and
in response that interference is detected, sending a previous channel profile used in a last sounding, or in response that no interference is detected, sending the updated channel profile.

2. The wireless communication method according to claim 1, wherein the step of determining whether any interference is detected includes:
detecting interference from at least one of coexisting wireless signals comprising BT (blue tooth) signals, ZigBee signals, Wi-Fi signals and PCIE (Peripheral Component Interconnect Express) signals.

3. The wireless communication method according to claim 1, wherein in response that interference is detected, beamforming channel profile engine lock is performed to send the previous channel profile used in the last sounding.

4. The wireless communication method according to claim 1, wherein in response that no interference is detected, beamforming channel profile engine unlock is performed to send the updated channel profile.

5. A wireless communication device including:
a wireless transceiver module for transmitting and receiving wireless signals from other wireless devices; and
a controller coupled to and for controlling the wireless transceiver module,
wherein the controller is configured for:
receiving a beamforming sounding signal;
generating an updated channel profile in consideration of the beamforming sounding signal;
determining whether any interference is detected; and
in response that interference is detected, sending a previous channel profile used in a last sounding, or in response that no interference is detected, sending the updated channel profile.

6. The wireless communication device according to claim 5, wherein in determining whether any interference is detected, the controller is configured for:
detecting interference from at least one of coexisting wireless signals comprising BT (blue tooth) signals, ZigBee signals, Wi-Fi signals and PCIE (Peripheral Component Interconnect Express) signals.

7. The wireless communication device according to claim 5, wherein in response that interference is detected, the controller performs beamforming channel profile engine lock to control the wireless transceiver module for sending the previous channel profile used in the last sounding.

8. The wireless communication device according to claim 5, wherein in response that no interference is detected, the controller performs beamforming channel profile engine unlock to control the wireless transceiver module for sending the updated channel profile.
